(19) United States
(12) Patent Application Publication
(10) Pub. No.: US 2011/0205399 A1
(43) Pub. Date: Aug. 25, 2011

(54) Arranging Images Into Pages Using Content-based Filtering And Theme-based Clustering

(76) Inventors: Yuli Gao, Sunnyvale, CA (US); Stephen Philip Cheatle, Bristol (GB)

(21) Appl. No.: 13/125,968

(22) PCT Filed: Feb. 26, 2009
(86) PCT No.: PCT/US09/35279

§ 371 Date: Apr. 25, 2011

Related U.S. Application Data
(60) Provisional application No. 61/108,523, filed on Oct. 26, 2008.

(51) Int. Cl. G06K 9/62; H04N 5/76

(52) U.S. Cl. 348/231.99; 382/224; 348/E05.031

(57) ABSTRACT

To arrange images into pages, images captured by at least one imaging device are received. Content-based filtering is applied for removing at least one of the received images to produce a collection of the images. Theme-based clustering is then performed on the images in the collection to produce plural clusters of images, where the plural clusters of images are associated with respective themes that are based on time and at least one other attribute that provides an indication of thematic similarity between the images. The plural clusters of images are mapped to respective pages of an output representation.

### BACKGROUND

Digital cameras (still cameras and/or video cameras) allow users to capture large amounts of digital images. Capacities of memory cards used in such digital cameras have increased while the costs of the memory cards have come down. Also, some digital cameras now include disk-based storage with relatively large capacity.

Although it is easy to capture large amounts of digital images, organizing such digital images is often a challenge to users. Having to manually search through hundreds or even thousands of digital images to organize the images is usually a tedious process that can take a long time.

Some techniques have been proposed to perform automated clustering of collections of digital images; however, such techniques may not produce pleasing results or may suffer from inefficiencies.

### BRIEF DESCRIPTION OF THE DRAWINGS

Some embodiments of the invention are described with respect to the following figures:

FIG. 1 is a block diagram of an exemplary system that incorporates an embodiment of the invention;

FIG. 2 is a flow diagram of a process of paginating a collection of images into pages, in accordance with an embodiment;

FIG. 3 is a flow diagram of performing content-based filtering, according to an embodiment; and

FIG. 4 is a flow diagram of performing theme-based clustering, according to an embodiment.

### DETAILED DESCRIPTION

In accordance with some embodiments, a mechanism is provided to perform automated theme-based pagination of digital images that groups images by theme onto pages of an output representation. The output representation that includes the pages of images can be a photoalbum or photobook. Alternatively, the output representation can also be a photo slideshow or any other type of output that includes pages. Generally, a photoalbum or photobook refers to a container of digital images that arranges the digital images onto separate distinct pages by theme to allow the digital images to be presented in an organized and aethestically pleasing manner. The terms “photobook” and “photoalbum” are used interchangeably herein. A photo slideshow provides multiple slides (pages) that are sequentially displayed to a user.

A photoalbum can be a digital document that a user can access using an electronic device such as a computer, personal digital assistant, or the like. Alternatively, a photoalbum can be a physical album having multiple pages on which images are arranged; for example, after digital images have been paginated using a technique according to some embodiments, the pages of digital images can be printed and assembled into a physical photoalbum.

A “digital image” (or more simply “image”) refers to a digital representation of an object (e.g., scene, person, etc.). A digital image may be acquired using a camera, such as a still camera or a video camera.

Using digital cameras, users can capture large amounts of images. The pagination mechanism according to some embodiments provides a convenient and efficient manner of organizing a large amount of digital images onto pages in a theme-based manner. The pages of the photoalbum that result from the pagination mechanism are associated with respective themes, where a theme can be based on people in the images, the scenery of the images, colors in the images, and so forth.

To improve efficiency, the theme-based pagination mechanism according to some embodiments performs content-based filtering to remove images that may not be desirable in the photoalbum. Examples of images that can be removed from a collection can include those images of relatively low quality, those images that are considered not interesting, those images that are duplicative, and/or images that are manually marked by users as undesirable.

The content-based filtering uses one or more filtering criteria, including one or more of the following: a sharpness criterion that allows a determination of whether or not an image is too blurry; an interestingness criterion that allows a determination of whether or not an image is boring or interesting; and a duplication criterion that allows a determination of whether one image is a duplicate of another image.

By applying content-based filtering according to some embodiments, the quantity of images that have to be considered for pagination can be reduced, which reduces the computation burden of performing further tasks involved in the pagination of images. Moreover, by performing the content-based filtering, it is more likely that the images that are ultimately output to the photoalbum pages would result in a well-designed and aesthetically pleasing photoalbum.

After content-based filtering has been performed to produce a reduced set of images (where some of the images in the original collection of images have been removed by using the one or more filtering criteria noted above), the pagination mechanism next performs theme-based clustering. The theme-based clustering considers several clustering attributes, including a time attribute and at least another attribute that provides an indication of thematic similarity between the received images. The time attribute specifies that images that were captured closer in time tend to be more closely related than images that were captured farther apart in time.

In some embodiments, the at least another attribute that is considered in combination with the time attribute to perform theme-based clustering can be selected from among the following attributes: a color attribute (to allow comparisons of images to determine how closely related in color the images are); a number-of-faces attribute (to allow images to be clustered based on the number of people in the image); and a location attribute (to allow images to be clustered based on geographic location).

The clustering of images using the number-of-faces attribute may not be a simplistic grouping of images with exactly the same number of faces. Stronger emphasis may be placed on the distinction between images with zero faces and images with greater than zero faces. A group of images each with a single face may form a strong cluster. Alternatively, a group of images each with more than one face may form a cluster. It is unlikely that it would be desirable to reject images with 3 or 5 faces from a group where the other images have 4 faces. Another rule is that if there is a large group shot that contains, say, more than six faces, this image can be set to occupy an entire page because such a group shot is usually very difficult to obtain.

Another attribute that can be considered for grouping images is a face-identity attribute that attempts to group images containing the same person(s). For example, it may be desirable to place images of the same person(s) on one page to provide a person-centric theme.

Using the clustering attributes, the theme-based clustering produces plural clusters of images, where each cluster includes at least one image. The plural clusters correspond to plural themes. The clusters are mapped to respective pages of the photoalbum.

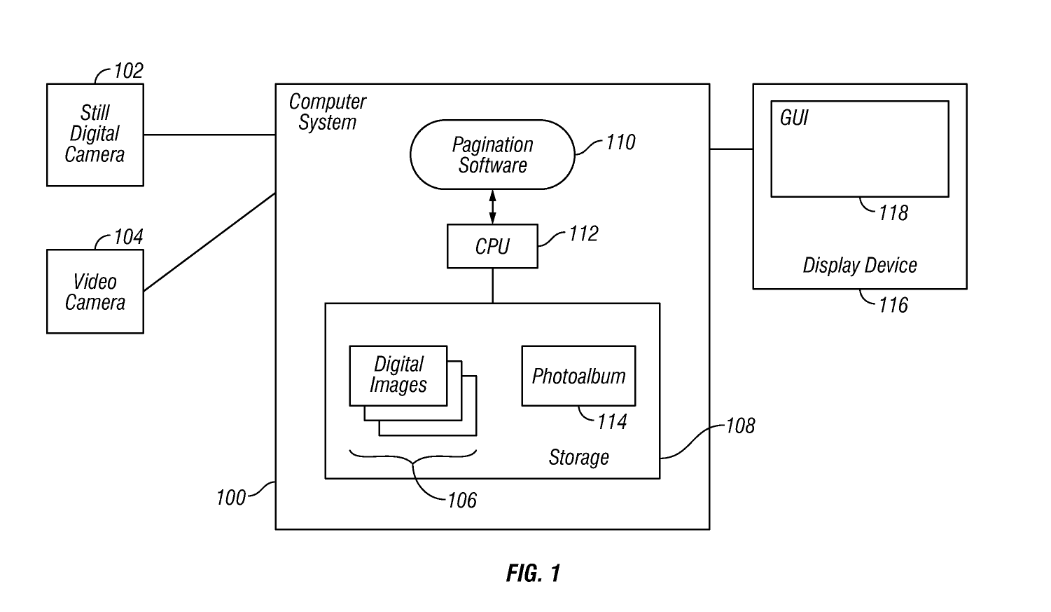

FIG. 1 illustrates an exemplary arrangement that includes a computer system 100 and one or more imaging devices, including a still digital camera 102 and a video camera 104. The still digital camera 102 and video camera 104 are capable of capturing digital images that can be transferred to the computer system 100 when the still digital camera 102 and video camera are connected to the computer system 100, such as through an input/output port (e.g., Universal Serial Bus or USB port) or over a network (e.g., local area network, wide area network, Internet, etc.).

The digital images captured by the still digital camera 102 and/or video camera 140 are received by the computer system 100 and stored as a collection 106 of digital images in a storage 108 of the computer system 100. The storage 108 can be a disk-based storage, such as magnetic disk-based storage or optical disk-based storage. Alternatively, the storage 108 can include semiconductor storage devices.

The computer system 100 also includes a pagination software 110 that is executable on one or more central processing units (CPUs) 112. The pagination software 110 performs the pagination technique according to some embodiments to paginate the images in the collection 106 onto pages of a photoalbum 114, also stored in the storage 108.

Although the computer system 100 is depicted as being a singular computer system, it is noted that in an alternative implementation, the computer system 100 can be made up of multiple computers, where the pagination software 110 can be executed on the multiple computers in a distributed manner.

A display device 116 is also connected to the computer system 100. The display device 116 displays a graphical user interface (GUI) 118 associated with the pagination software 110. The GUI 118 can be used to display the photoalbum 114 including the pages of the photoalbum. Also, the GUI 118 can be used to perform control with respect to the pagination software 110, such as to instruct the pagination software 110 to perform pagination with respect to a collection of images. The GUI 118 can also be used to adjust settings of the pagination software 110, such as to select which filtering criteria and clustering attributes to use in performing the pagination.

In addition to presenting the photoalbum 114 in the display device 116, it is noted that the photoalbum 114 can also be output by other mechanisms. For example, the pages of the photoalbum 114 can be printed on a color printer. Alternatively, the photoalbum can be sent to a remote user over a network. In this latter context, the computer system 100 can be a computer system associated with a service provider, such as provider that sells the services of paginating images provided by customers.

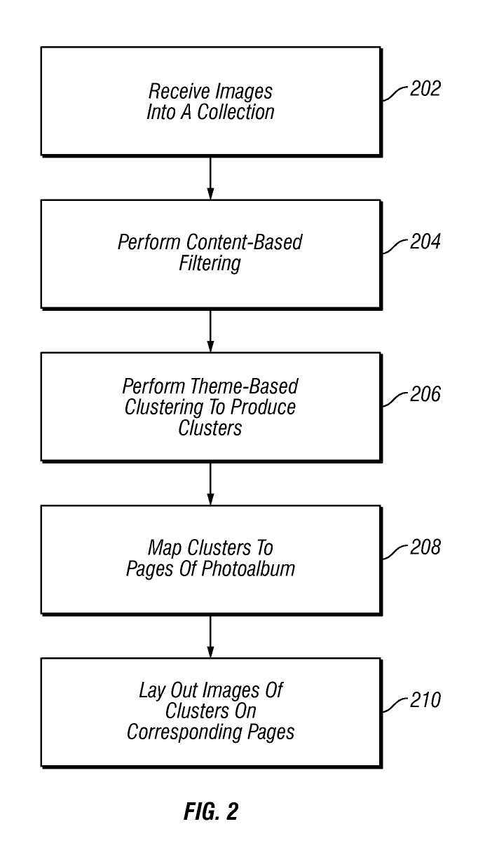

FIG. 2 depicts a general flow diagram for performing pagination according to an embodiment. Images are received (at 202), such as by the computer system 100 of FIG. 1 from one or more imaging devices. The images are collected into the collection 106 (or into multiple collections). Note that the images can be received in real-time for processing, in which case the pagination performed by the pagination software 110 is performed as new images are received. Alternatively, the collection of images may be pre-stored and the pagination is performed in offline mode (in other words, no new images are received as the pagination executes).

The collection of received images can be quite large. To enhance efficiency in processing and to avoid inserting undesirable images into a photoalbum, content-based filtering is performed (at 204) by the pagination software 110. The content-based filtering may remove one or more images from the collection if one or more filtering criteria (as discussed above) is satisfied. Note that in some cases, application of content-based filtering may not remove any images if the images do not satisfy any of the filtering criteria. However, generally, the goal of the content-based filtering is to produce a reduced set of images.

Next, the pagination software 110 performs (at 206) theme-based clustering of the images in the reduced set. The theme-based clustering considers various clustering attributes, including a time attribute, a color attribute, a number-of-faces attribute, and a location attribute. Other clustering attributes can also or alternatively be considered, such as a face-identity attribute, a type of object attribute (e.g., to group images containing cars, images containing airplanes, etc.), a type of activity attribute (e.g., to group images relating to activities such as soccer, basketball, etc.), or other clustering attributes. The theme-based clustering produces multiple clusters corresponding to multiple themes.

The clusters are then mapped (at 208) to corresponding pages of the photoalbum. The mapping can be one-to-one mapping, or if there are too many images in a cluster, the images of the cluster can be mapped to multiple pages. Alternatively, if there are not enough images in some clusters, such clusters can be mapped onto one page.

More generally, instead of mapping based on the number of images in a cluster, the mapping can be based on page-space requirements of images in the cluster. It can be determined that certain images should be allocated more photoalbum page space than others. Clusters containing images requiring larger amounts of album space may be allocated more album pages. One example of when this is desirable is in the case of a cluster containing an image of a large group of people. It is desirable to have the large group image occupy a large amount of space on a page, possibly the entire page. In this case, a cluster containing a large group shot may be allocated more than one page even if the number of images in the cluster is not that great.

Criteria for determining the relative amount of album page space to allocate for an image can be determined either manually (by allowing users to specify “favorites” or by use of a “star rating” scheme, for example), or automatically by detecting “busy” images which should occupy more space. Examples of “busy-ness” that can be automatically detected include large groups of people (face count greater than six, for example), and images which include a large number of small regions with significantly different colors. These metrics are the same as the “weights” criteria described below.

The images of the clusters are laid out (at 210) on corresponding pages of the photoalbum. In laying out images of a cluster on a page, the size of each image can be determined based on a weight assigned to the respective image. Images in a cluster may be associated with weights that indicate relative sizes of the images once placed onto the page. A higher weight for a first image may indicate that the first image is to have a larger size than a second image, which may be associated with a lower weight. In one example, a higher weight may be assigned to images with a larger number of faces, which indicates that such images may be group photographs that would benefit from being larger so that the faces can be more clearly viewed. Also, images with a relatively large amount of texture (busy images) should also be assigned higher weights such that they are made larger on a corresponding page of the photoalbum. In addition, weights can also be assigned based of face sizes and/or color variation.

To simplify the process of laying out images on pages, predefined templates can be used. Given a theme of a cluster, the theme is matched to one of the templates. The template with the highest matching score is used to layout the images of the cluster. In one implementation, this matching involves selecting templates with the same number of image receptacles, with the same orientations, as the images allocated to the page. If there is a choice of matches at this stage, the alternatives can be ranked according to the degree the relative image size weights are satisfied, for example.

In other implementations, more sophisticated layout mechanisms can be employed. One such layout mechanism is described in C. Brian Atkins, “Blocked Recursive Image Composition,” Proceeding of the 16th ACM international conference on Multimedia, pp. 821-824 (Oct. 26, 2008). Such algorithms are capable of effectively designing a template to suit a specific combination of image shapes, together with any additional specifications such as relative weight for images.

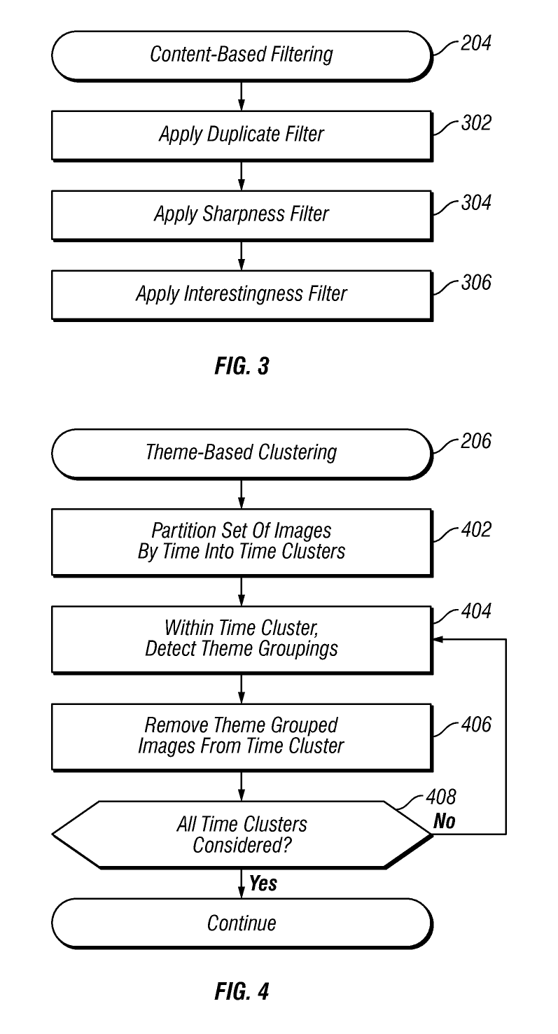

The content-based filtering 204 is illustrated in greater detail in FIG. 3. The content-based filtering 204 includes applying (at 302) duplicate filtering, applying (at 304) sharpness filtering, and applying (at 306) interestingness filtering.

Although the three different filters in FIG. 3 are shown in a specific order, it is noted that the filters can be applied in different orders in other embodiments. Also, some of the filters shown in FIG. 3 can be omitted. In other implementations, other filters can be added.

The duplicate filtering applied at 302 removes duplicate images. Two images can be considered duplicate even if they are not identical, so long as the two images are of sufficient similarity to one another according to computed one or more metrics. Users tend to take multiple shots of the same scenes, people, or other objects. The multiple shots may have the same view or may have different views (e.g., different angles of the camera with respect to the object being photographed).

Duplicate detection can be purely based on similarity of images. For example, color clusters in a pair of images can be extracted, and color similarity can be ascertained by comparing the color clusters. Image similarity can be based on the EMD (Earth Movers Distance) on the color clusters of the pair of images. In other implementations, other metrics can be used to represent similarity of color clusters between two images. In one implementation, a fast color quantization algorithm can be applied to an image to extract its major color clusters. One example of such a fast color quantization algorithm is described in Jun Xiao et al., “Mixed-Initiative Photo Collage Authoring,” Proceeding of the 16th ACM international conference on Multimedia, pp. 509-518 (Oct. 26, 2008).

Alternatively, duplicate detection can also be based on time. Duplicate shots tend to be taken close in time with respect to each other. Thus, if time information is available in the metadata associated with the images, then the time information can be extracted to use in duplicate detection. In one implementation, the metadata of an image can be in the EXIF (Exchangeable Image File Format). Time information contained in an EXIF metadata is in the form of a timestamp. In other implementations, the time information associated with an image can be of another format.

To assist in duplicate detection, a binary classifier can be trained to perform duplicate detection in a pair-wise manner, where images in a pair are compared to each other to determine whether the images are duplicates of each other. The binary classifier outputs a result, where the result can indicate that the images in the pair are duplicates of each other, or the images in the pair are not duplicates. The binary classifier can be trained using a training set of images that have been manually labeled by users. Once trained, the binary classifier can process new images to identify duplicates.

Features of images considered by the classifier in identifying duplicate images include the color-cluster similarity discussed above, and the proximity in time associated with the images. A duplicate detection function Dup(X,Y) can be constructed by building a classifier on a time difference feature Dₜ(X, Y), where X and Y represent two images that are being compared for duplication. The time difference feature Dₜ(X, Y) represents the distance between the timestamps of images X and Y. The classifier is also built on a color distance feature D_{c}(X, Y) (which considers EMD distances to determine similarities between color clusters in images X and Y). The duplicate detection function Dup(X, Y) can be applied on every possible pair of images.

In one implementation, a duplicate graph can be constructed, where two nodes (representing two respective images) in the graph are connected if and only if they are duplicates (as identified by the binary classifier discussed above). Connected nodes can be identified in the graph. A node associated with the better of the two duplicate images is kept, while the other node representing the duplicate image is removed from the duplicate graph. A “better” image can be image that has a larger number of faces, has a higher sharpness score, has a higher color variance, and so forth. After duplicate nodes are removed from the duplicate graph, the final result is a list of non-connected nodes, which correspond to non-duplicate images.

The sharpness filtering that is applied (at 304) is based on a sharpness criterion. The sharpness filter is designed to remove blurry images which often result from motion or lack of focus. The blurriness of the image often weakens the major edges in images.

In one implementation, the following sharpness score (Q) can be used:

Q=strength(e)/entropy(h),

where strength(e) is the average edge strength of the top 10% strongest edges and entropy(h) is the entropy of a normalized edge strength histogram.

Intuitively, non-blurry images have stronger edges and more peaky edge strength distribution—therefore a non-blurry image has a larger strength(e) and smaller entropy(h), resulting in a larger Q value. A predefined sharpness threshold Tₑ can be set such that images with sharpness scores less than Tₑ are removed from the collection.

Instead of using the above sharpness score, other types of scores can be used in other embodiments to represent the sharpness (or lack of sharpness) of an image.

The interestingness filter applied (at 308) uses an interestingness filtering criterion. Sometimes, users take shots that are not “interesting.” An uninteresting or boring image can be identified as an image that has low variation in color. To quantify the “interestingness” score, a fast color quantization algorithm as noted above can be applied to an image to extract its major color clusters.

Next, a homogeneous reference image is created with the mean color of the maximum color cluster. By doing this, a “boring” version of the original image is created, so that if the original image is indeed low in color variation, its “color distance” from this boring image should be small. To measure the color distance between the original image and the generated boring image, the EMD distance on the color clusters extracted from the two images are computed. The computed EMD distance is compared to a threshold T, (which is predefined) such that any image with an interestingness score (EMD distance) lower than T, is removed from the image collection.

Theme-based clustering 206 is illustrated in FIG. 4. As discussed above, theme-based clustering is performed on a reduced set of images that contains generally fewer images than the original collection of images due to application of the content-based filtering (204 in FIG. 3).

A theme generally means similarity in some dimension such as time, color, people, and location. Similarity in time can be computed using the time difference function Dₜ(X, Y) (discussed above), similarity in color can be computed using the color distance function D_{c}(X, Y) (discussed above), and similarity based on people can be computed based on face detection function F(X). The face detection function F(X) calculates the number of faces in an image X. Another function can be used to identify similarity of places represented by two images. If the metadata of images contain GPS (global positioning system) coordinates, then such position information can be used to perform clustering according to location.

To reduce the search space, the following reasonable observation is used: images that are taken closer in time should be given higher priority to be grouped together in the clustering algorithm than images that are further apart in time. The set of images is first partitioned (at 402) into non-overlapping time clusters. For a time ordered sequence of images I₁, I₂, . . . , Iₙ₊₁ taken at times t₁, t₂, . . . tₙ₊₁ the time gaps are g₁, g₂, . . . gₙ, where gᵢ=tᵢ₊₁−tᵢ. A simple way to partition the image sequence into time clusters is to pick a threshold G such that the image sequence is broken into subsets at any gap gᵢ where gᵢ>G. The resulting sequence of image subsets (time clusters) is S₁, S₂, . . . , Sₘ, where m≦n+1.

Next, within each resulting time cluster, the theme-based clustering attempts to detect (at 404) theme groupings using a set of theme group detectors, including the functions described above to detect time similarity, color similarity, number of faces, face identities, location proximity, and/or similarity based on other clustering attributes. Images that are grouped successfully are removed (at 406) from the time cluster and passed to 208 for pagination. The process may be repeated on the images remaining in the time cluster to find additional theme clusters from the time cluster. When the images in the time cluster have been exhausted, or no further clusters can be found, the algorithm iterates to the next time cluster until the time cluster sequence is exhausted, as determined (at 408).

This mechanism permits the order in which images appear in the photoalbum to deviate from the temporal order in which the images were taken. Although the time clusters retain their temporal sequence in the album, the theme-based clustering used for page grouping can cause the images within a time cluster to be re-ordered when they appear in the photoalbum.

In one embodiment, the theme group detectors work as follows. Given a set of image nodes, the detector first constructs a theme graph containing all the nodes that represent images of the reduced set of images. Next, an edge between any two nodes is constructed if the following one or more theme conditions are satisfied: the images are similar in color (based on comparing the output of the function Dc(X, Y) to a color similarity threshold), the images are close in time (based on comparing the output of the function Dt(X, Y) to a time threshold), the images are determined to be similar based on the number of faces in each image (discussed further above), the images contain same person(s), and the images are taken in similar location (based on comparing the output of a function that calculates a geographic distance between two images to a location threshold). Then theme groups can be identified by finding cliques or connected components of the theme graph.

Another task that can be performed by the pagination software 110 according to some embodiments is the selection of the cover image to use as the cover for the photoalbum. The pagination software 110 picks candidate cover images from a set of images that is subject to pagination. It is assumed that bursts of activity (a “burst” refers to a relatively large number of image shots taken within a small amount of time) are associated with interesting events (to the user taking the image shots). Therefore, a candidate cover image is an image that occurs within one of the bursts. The candidate cover image to pick from each burst can be based on some criterion, such as a criterion relating to number of faces (e.g., the candidate cover image selected from a burst of images is the image having the largest number of faces). Other criteria can be used in other implementations.

The candidate cover images are presented to a user, who can then select the cover image from among the candidate cover images to use for the photoalbum.

Instructions of software described above (including the pagination software 110 of FIG. 1) are loaded for execution on a processor (such as one or more CPUs 112 in FIG. 1). The processor includes microprocessors, microcontrollers, processor modules or subsystems (including one or more microprocessors or microcontrollers), or other control or computing devices. As used here, a “processor” can refer to a single component or to plural components (e.g., one CPU or multiple CPUs).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

1. A method executed by a computer of arranging images into pages, comprising:
receiving images captured by at least one imaging device;
applying content-based filtering for removing at least one of the received images if at least one filtering criterion is satisfied to produce a collection of the images;
performing theme-based clustering of the images in the collection to produce plural clusters of images, wherein the plural clusters of images are associated with respective themes that are based on time and at least one other attribute that provides an indication of thematic similarity between the images; and
mapping the plural clusters of images to respective pages of an output representation.

2. The method of claim 1, wherein applying the content-based filtering comprises identifying duplicate images and removing duplicate images.

3. The method of claim 1, wherein applying the content-based filtering comprises removing the at least one of the received images if the at least one criterion relating to sharpness of the received images is satisfied.

4. The method of claim 1, wherein applying the content-based filtering comprises removing the at least one of the received images if the at least one criterion indicating interestingness of the received images is satisfied.

5. The method of claim 1, wherein the at least one other attribute comprises an attribute relating to similarity of color between the images of the collection.

6. The method of claim 5, wherein the at least one other attribute further includes another attribute relating to a number of faces of people or identity of people in each of the images in the collection.

7. The method of claim 5, wherein the at least one other attribute further includes another attribute relating to locations depicted by the images in the collection.

8. The method of claim 1, claims, wherein mapping the clusters of images to respective pages of the output representation comprises mapping the clusters of images to respective pages of a photoalbum.

9. The method of claim 1, further comprising laying out the images of the clusters in respective pages, wherein laying out the images comprises assigning weights to multiple images within a particular one of the clusters, and wherein the weights indicate respective sizes of the multiple images in the page corresponding to the particular cluster.

10. The method of claim 9, further comprising assigning a number of pages to the particular cluster based on the weights of the images in the particular cluster.

11. The method of claim 9, wherein the weights are determined based on at least one criterion selected from among: color variation, number of faces, face sizes, and a user specification.

12. An article comprising at least one computer-readable storage medium containing instructions that upon execution cause a computer to perform the method of claim 1.

13. A computer system comprising:
a storage to store images; and
a processor to:
produce a set of images by applying content-based filtering to the stored images such that at least one of the stored images is removed from the set if at least one filtering criterion is satisfied;
generate plural clusters, wherein each cluster includes at least one of the images in the set, wherein the plural clusters are generated based on a time attribute of the images in the set and further based on at least one other attribute that provides an indication of thematic similarity between the images in the set; and
output the images of the clusters to corresponding pages of an output representation.

14. The computer system of claim 13, wherein the content-based filtering is based on one or more of the following filtering criteria: a duplication criterion, a sharpness criterion, and an interestingness criterion.

15. The computer system of claim 13, wherein the at least one other attribute comprises an attribute selected from among: an attribute relating to similarity of color between the images of the set, an attribute relating to a number of faces of people in each of the images in the set, an attribute relating to identity of faces in each of the images in the set, a type of object attribute, a type of activity attribute, and an attribute relating to a location of the images in the set.

16. The computer system of claim 13, wherein the processor is to further identify candidate cover images for the output representation, and to present the candidate cover images to a user for selection as the cover image for the output representation.
